(19) United States
(12) Patent Application Publication
(10) Pub. No.: US 2023/0176363 A1
(43) Pub. Date: Jun. 8, 2023

(54) IMAGE-FORMING APPARATUS

(71) Applicant: SHARP KABUSHIKI KAISHA, Osaka (JP)

(72) Inventor: MANABU MATSUO, Osaka (JP)

(21) Appl. No.: 18/070,364

(22) Filed: Nov. 28, 2022

(30) Foreign Application Priority Data
Dec. 2, 2021 (JP) 2021-196475

(51) Int. Cl. G02B 26/12

(52) U.S. Cl. CPC G02B 26/123; G02B 26/125; G02B 26/127; G03G 15/04045

(57) ABSTRACT

In an image-forming apparatus, an optical scanning device that is adjustable in a turn available manner around a turn axis line parallel to an axis line orthogonal to a main scanning direction of a light beam is attached to an image-forming apparatus body. The image-forming apparatus body has a shaft support that supports the optical scanning device in a turn available manner around a turn axis line and a holder facing a housing at a position different from that of the shaft support. The optical scanning device is held by the image-forming apparatus body in a state in which an elastic member is sandwiched between the housing and the holder in a pressed manner.

### BACKGROUND OF THE INVENTION

### Field of the Invention

The present disclosure relates to image-forming apparatuses, such as photocopiers, multifunction peripherals, printers, and facsimile machines.

### Description of the Background Art

FIG. 14 is a cross-sectional view schematically illustrating a general image-forming apparatus 100X viewed from front. FIGS. 15A and 15B are perspective views of a front side and a rear side of an optical scanning device 200X of the image-forming apparatus 100X, respectively, viewed from above. In FIGS. 14, 15A, and 15B, a reference character X represents a depth direction, a reference character Y represents a lateral direction (a width direction), a reference character Z represents a vertical direction (a height direction), and a reference character X1 represents a main scanning direction.

As illustrated in FIGS. 14, 15A, and 15B, in the general image-forming apparatus 100X, the optical scanning device 200X is disposed in an image-forming apparatus body 110X such that the optical scanning device 200X is adjustable by turn around a turn axis line λ which is parallel to an axis line which is perpendicular to the main scanning direction X1 of a light beam L (refer to FIG. 15A) on a deflecting-and-scanning surface of the light beam L. A housing 201X of the optical scanning device 200X is provided with a turn shaft 260X centered on the turn axis line λ. Specifically, in the housing 201X of the optical scanning device 200X, a first turn shaft 261X (refer to FIG. 15A) is disposed on an emission side of the light beam L, and a second turn shaft 262X (refer to FIG. 15B) is disposed on an opposite side of the emission side.

FIGS. 16A to 16C are side views schematically illustrating the optical scanning device 200X in a state in which the optical scanning device 200X is adjusted by being turned around the turn axis line λ.

An eccentric cam member 263 abuts on the housing 201X in a position corresponding to one side of a bottom surface in the depth direction X of the housing 201X of the optical scanning device 200X. The eccentric cam member 263 can rotate about a rotation axis line 8 parallel to the turn axis line λ. When the eccentric cam member 263 rotates about the rotation axis line β, the optical scanning device 200X turns around the turn axis line λ. Here, in FIG. 16A, a state in which the optical scanning device 200X is parallel to the depth direction X is illustrated. In FIG. 16B, a state in which one side (an operation side) in the depth direction X of the optical scanning device 200X is higher is illustrated. In FIG. 16C, a state in which the other side (a side opposite to the operation side) in the depth direction X of the optical scanning device 200X is higher is illustrated.

Then, a certain portion (for example, a side opposite to the emission side of the light beam L of the housing 201X) of the housing 201X is fixed on the image-forming apparatus body 110X by a fixing member, such as a bis, such that a scanning trajectory a of the light beam L (refer to FIG. 15A) is parallel to a rotation axis line 6 of a photoreceptor drum 3X (refer to FIG. 14) which acts as an image carrier. Specifically, any portion of the housing 201X (for example, the emission side of the light beam L of the housing 201X) may not be fixed to the image-forming apparatus body 110X by a fixing member.

In such an image-forming apparatus, vibration from the image-forming apparatus body, such as vibration caused by drive of an image former or vibration caused by drive of a sheet transport system in an image-forming apparatus body, is transmitted to the optical scanning device, and therefore, an image written on the image carrier (the photoreceptor) may be disrupted and an image defect may occur.

Therefore, an object of the present disclosure is to provide an image-forming apparatus that has an optical scanning device attached to an image-forming apparatus body such that the optical scanning device is adjustable by turn around a turn axis line parallel to an axis line orthogonal to a main scanning direction of a light beam on a deflecting-and-scanning surface of the light beam and that can suppress transmission of vibration from the image-forming apparatus body to the optical scanning device so that generation of an image defect due to disruption of an image written on an image carrier is efficiently suppressed.

### SUMMARY OF THE INVENTION

To address the above problem, according to an aspect of the present disclosure, an image-forming apparatus has an optical scanning device attached to an image-forming apparatus body such that the optical scanning device is adjustable by turn around a turn axis line that is parallel to an axis line orthogonal to a main scanning direction of a light beam on a deflecting-and-scanning surface of the light beam. The image-forming apparatus body includes a shaft support that supports the optical scanning device in a turn available manner around the turn axis line and a holder that faces a housing of the optical scanning device in a position different from the shaft support. The optical scanning device is held by the image-forming apparatus body in a state in which an elastic member is sandwiched between the housing and the holder in a pressed manner.

According to the present disclosure, transmission of vibration from the image-forming apparatus body to the optical scanning device can be suppressed, and accordingly, occurrence of image defects due to disturbances of an image written to the photoreceptor drum 3 can be efficiently suppressed.

### BRIEF DESCRIPTION OF THE DRAWINGS

FIG. 1 is a cross sectional view schematically illustrating an image-forming apparatus according to an embodiment viewed from front.

FIG. 2A is a perspective view of a front side of an optical scanning device of the image-forming apparatus illustrated in FIG. 1 as viewed from above.

FIG. 2B is a perspective view of a rear side of the optical scanning device of the image-forming apparatus illustrated in FIG. 1 as viewed from above.

FIG. 3A is a perspective view of a front side of the optical scanning device and a front side of a photoreceptor drum of the image-forming apparatus illustrated in FIG. 1 as viewed from above in a state in which an upper cover portion is removed.

FIG. 3B is a perspective view of the front side of the optical scanning device illustrated in FIG. 3A as viewed from a lower right.

FIG. 4 is a cross-sectional view of the optical scanning device illustrated in FIG. 3A as viewed from above.

FIG. 5A is an exploded perspective view of an image-forming apparatus according to a first embodiment before a photoreceptor unit and an optical scanning device are attached to a body frame as viewed from diagonally above on a front side.

FIG. 5B is an exploded perspective view of the image-forming apparatus according to the first embodiment before the photoreceptor unit and the optical scanning device are attached to the body frame as viewed from diagonally above on the front side.

FIG. 6 is a perspective view of the body frame, viewed from an optical scanning device side, in a state in which a portion on the optical scanning device side of the body frame is removed from the state illustrated in FIG. 5B.

FIG. 7 is a perspective view of an opening that emits a light beam in a state in which a portion of the body frame opposite to the optical scanning device side is removed from the state illustrated in FIG. 5B.

FIG. 8A is a perspective view of the body frame, viewed from the optical scanning device side, in a state in which the optical scanning device is removed from the state illustrated in FIG. 5B.

FIG. 8B is an enlarged perspective view of a holding portion illustrated in FIG. 8A.

FIG. 9 is a perspective view of the holding portion illustrated in FIG. 8A with the optical scanning device held via an example of an elastic member.

FIG. 10A is a perspective view of a holding portion illustrated in FIG. 9 with an optical scanning device held via an example of elastic members in an image-forming apparatus according to a second embodiment.

FIG. 10B is a perspective view of the holding portion illustrated in FIG. 9 with the optical scanning device held via another example of elastic members in the image-forming apparatus according to the second embodiment.

FIG. 11 is a perspective view of a body frame, viewed from an optical scanning device side, in a state in which a portion on an optical scanning device side of the body frame is removed from the image-forming apparatus according to a third embodiment.

FIG. 12A is a perspective view of the body frame, viewed from the optical scanning device side, in a state in which an optical scanning device is removed from the image-forming apparatus according to the third embodiment.

FIG. 12B is an enlarged perspective view of a holding portion illustrated in FIG. 12A.

FIG. 13 is a perspective view of the holding portion illustrated in FIGS. 12A and 12B with the optical scanning device held via an example of an elastic member in an image-forming apparatus according to the third embodiment.

FIG. 14 is a cross-sectional view schematically illustrating a general image-forming apparatus viewed from front.

FIG. 15A is a perspective view of a front side of an optical scanning device of the general image-forming apparatus as viewed from above.

FIG. 15B is a perspective view of a rear side of the optical scanning device of the general image-forming apparatus as viewed from above.

FIG. 16A is a side view schematically illustrating the optical scanning device of the general image-forming apparatus in a state in which the optical scanning device is adjusted by turn around a turn axis line.

FIG. 16B is a side view schematically illustrating the optical scanning device of the general image-forming apparatus in the state in which the optical scanning device is adjusted by turn around the turn axis line.

FIG. 16C is a side view schematically illustrating the optical scanning device of the general image-forming apparatus in the state in which the optical scanning device is adjusted by turn around the turn axis line.

### DESCRIPTION OF THE PREFERRED EMBODIMENTS

Embodiments of the present disclosure will be described hereinafter with reference to the accompanying drawings. In the following description, the same components are designated by the same reference numerals. The same components have the same name and the same function. Therefore, detailed descriptions thereof will not be repeated.

Image-Forming Apparatus

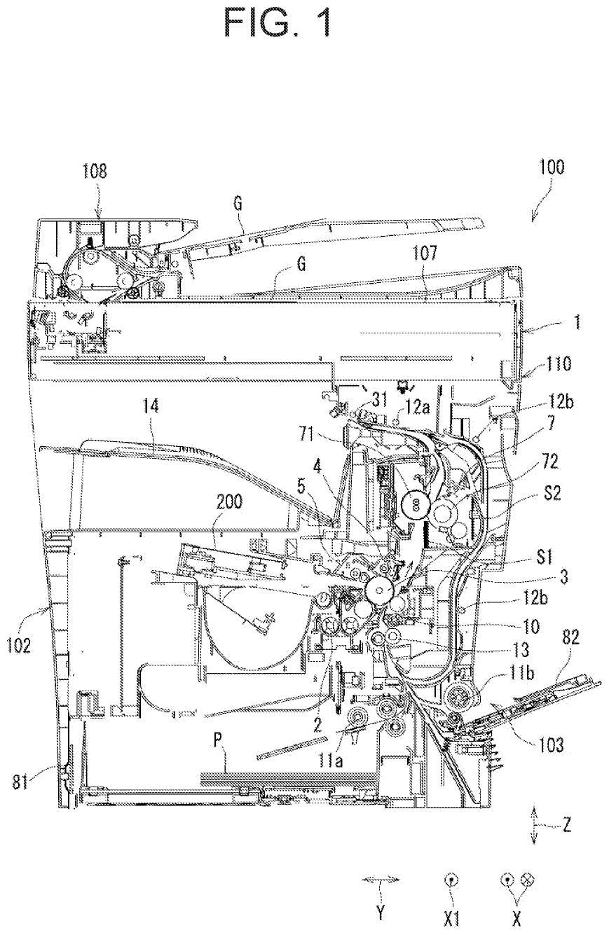

FIG. 1 is a cross-sectional view schematically illustrating an image-forming apparatus 100 according to an embodiment as viewed from front. In FIG. 1, a reference character X represents a depth direction, a reference character Y represents a lateral direction (a width direction), a reference character Z represents a vertical direction (a height direction), and a reference character X1 represents a main scanning direction.

The image-forming apparatus 100 according to this embodiment is a monochrome image-forming apparatus. The image-forming apparatus 100 performs an image-forming process in accordance with image data read by an image reading device 1 or image data transmitted from outside. Note that the image-forming apparatus 100 may be a color image-forming apparatus that forms multicolor and monochromatic images on paper P (sheets).

The image-forming apparatus 100 includes a document feeder 108 and an image-forming apparatus body 110. The image-forming apparatus body 110 includes an image former 102 and a sheet transport system 103.

The image former 102 includes an optical scanning device 200 (an optical scanning unit), a developing unit 2, a photoreceptor drum 3 that acts as an image carrier, a cleaner 4, a charging device 5, and a fixing unit 7. Furthermore, the sheet transport system 103 includes a paper feed tray 81, a manual paper feed tray 82, a discharge roller 31, and a discharge tray 14.

The image reading device 1 is disposed on an upper portion of the image-forming apparatus body 110 to read an image of a document G. The image reading device 1 includes a document placement table 107 on which the document G is placed. Furthermore, a document feeder 108 is disposed on an upper side of the document placement table 107. In the image-forming apparatus 100, the image of the document G read by the image reading device 1 is transmitted to the image-forming apparatus body 110 as image data, and the image is recorded on the paper P.

The image-forming apparatus body 110 has a paper transport path S1. The paper feed tray 81 or the manual paper feed tray 82 supplies the paper P to the paper transport path S1. The paper transport path S1 guides the paper P to the discharge tray 14 via a transfer roller 10 and the fixing unit 7. The fixing unit 7 heats and fixes, onto the paper P, a toner image formed on the paper P. Pickup rollers 11a and 11b, a transport roller 12a, a registration roller 13, the transfer roller 10, a fixing roller 71 and a pressure roller 72 in the fixing unit 7, and a discharge roller 31 are disposed in the vicinity of the paper transport path S1.

In the image-forming apparatus 100, the paper P supplied by the paper feed tray 81 or the manual paper feed tray 82 is transported to the registration roller 13. Thereafter, the paper P is transported to the transfer roller 10 by the registration roller 13 at a timing when the paper P is aligned with the toner image on the photoreceptor drum 3. The toner image on the photoreceptor drum 3 is transferred onto the paper P by the transfer roller 10. Thereafter, the paper P passes through the fixing roller 71 and the pressure roller 72 in the fixing unit 7 and is discharged onto the discharge tray 14 via the transport roller 12a and the discharge roller 31. When an image is to be formed not only on a front surface of the paper P but also on a back surface of the paper P, the paper P is transported in an opposite direction from the discharge roller 31 to a reverse paper transport path S2. The front and back of the paper P are reversed via reverse transport rollers 12b-12b and the paper P is again guided to the registration roller 13. After the toner image is formed and fixed on the back surface in the same manner as on the front surface, the paper P is discharged to the discharge tray 14.

Optical Scanning Device

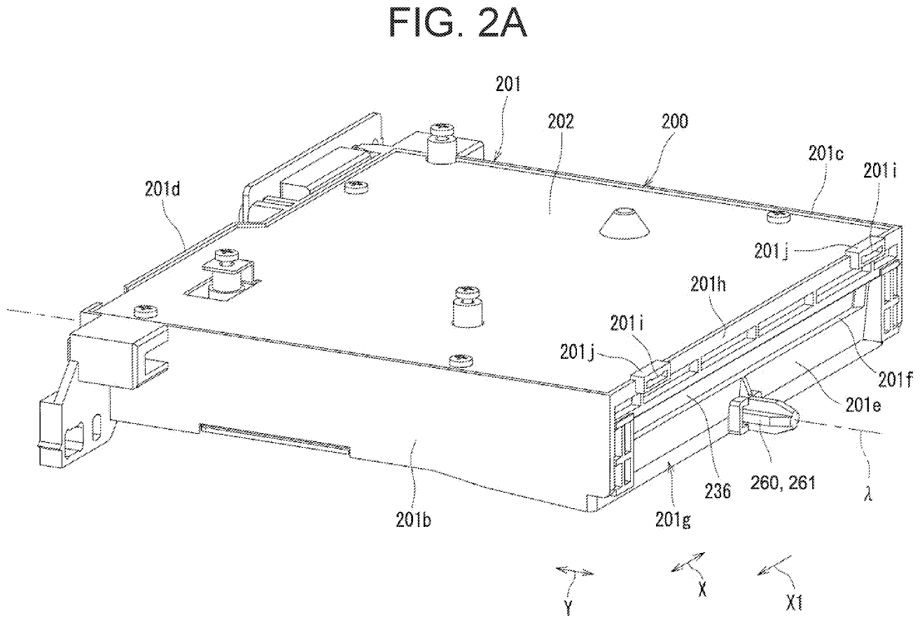

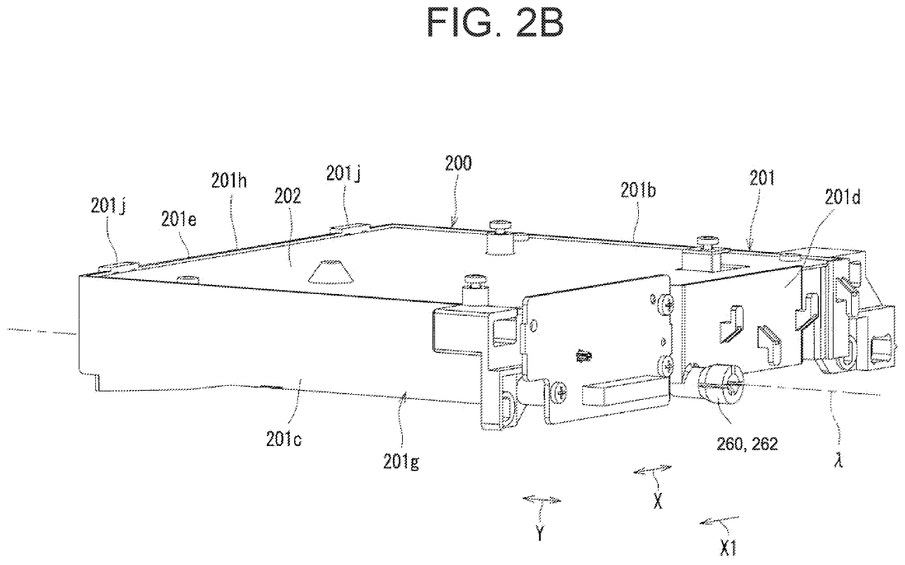

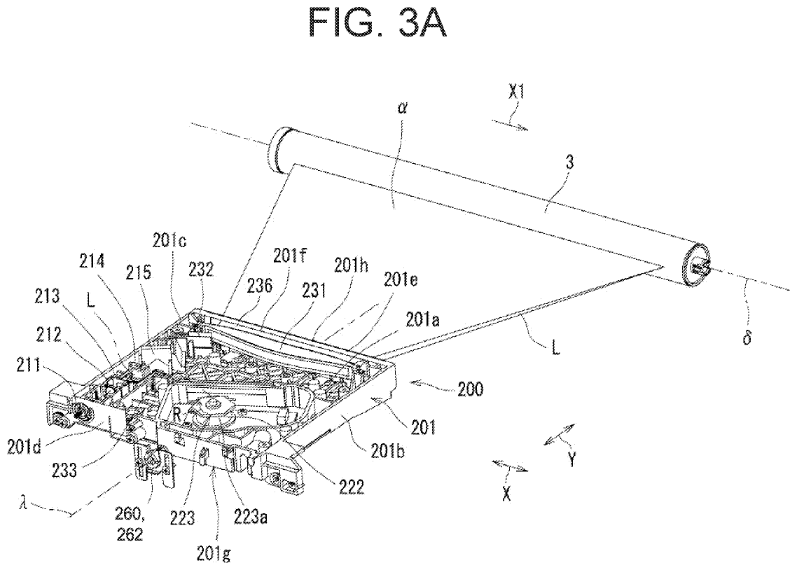

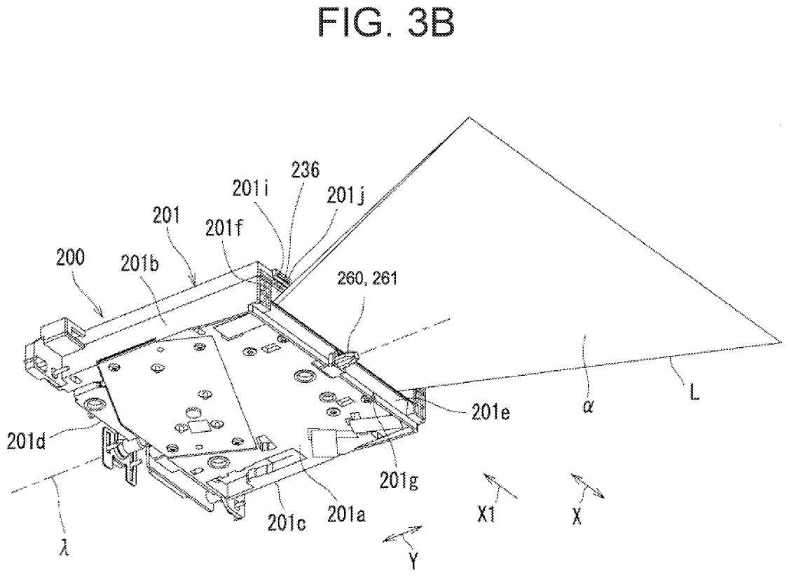

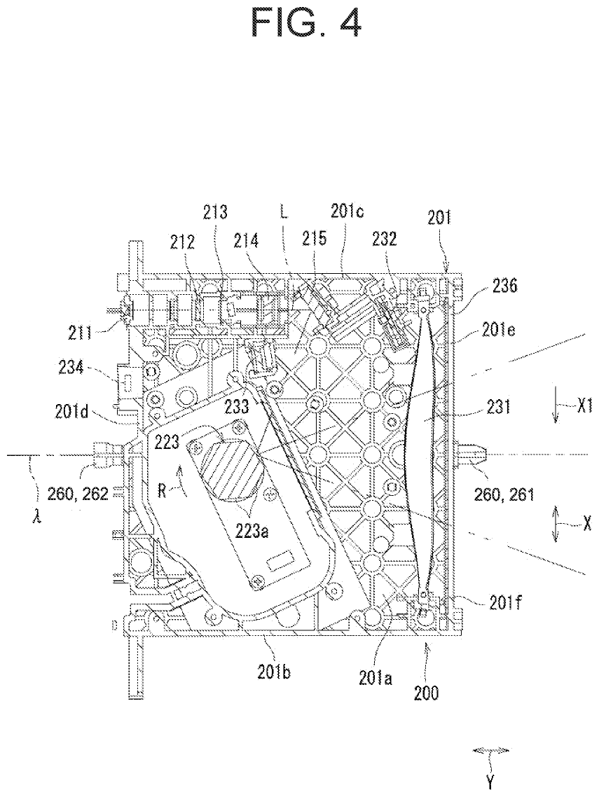

FIGS. 2A and 2B are perspective views of a front side and a rear side of the optical scanning device 200 of the image-forming apparatus 100 illustrated in FIG. 1, respectively, viewed from above. FIG. 3A is a perspective view of a front side of the optical scanning device 200 and a front side of the photoreceptor drum 3 of the image-forming apparatus 100 illustrated in FIG. 1 as viewed from upper left in a state in which a portion of a top cover 202 is removed. FIG. 3B is a perspective view of the front side of the optical scanning device 200 illustrated in FIG. 3A as viewed from lower right. FIG. 4 is a cross-sectional view of the optical scanning device 200 illustrated in FIG. 3A as viewed from above.

In the optical scanning device 200, the light beam L (a laser beam) from a light source 211 (a laser diode device) is transmitted through a collimator lens 212, thus becomes substantially parallel light, is narrowed by an aperture member 213, is transmitted through a cylindrical lens 214, becomes incident on and then reflected by a light source reflection mirror 215, and is incident on reflective surfaces 223a of a deflecting-and-scanning member 223 (a rotation polygon mirror). The deflecting-and-scanning member 223 is rotated at a constant angular velocity in a predetermined rotation direction R by a deflecting-and-scanning motor 222, sequentially reflects the light beam L on the individual reflective surfaces 223a, and repeatedly deflects the light beam L in the main scanning direction X1 at a constant angular velocity. The fθ lens 231 condenses the light beam L so that the light beam L has a predetermined beam diameter on the surface of the photoreceptor drum 3 in either of the main scanning direction X1 and the sub-scanning direction. Furthermore, the fθ lens 231 converts the light beam L, which is deflected at a constant angular velocity in the main scanning direction X1 by the deflecting-and-scanning member 223, so that the light beam L moves at a constant linear velocity on the photoreceptor drum 3. By this, the light beam L can repeatedly scan the surface of the photoreceptor drum 3 in the main scanning direction X1.

Furthermore, a beam detector 234 (Beam Detection Sensor (BD Sensor)) (refer to FIG. 4)) receives the light beam L reflected by the reflective mirror 232 for beam detection through a beam detection lens 233 (a light-collecting lens) immediately before main scanning (writing) of the photoreceptor drum 3 is started. The beam detector 234 receives the light beam L at a timing immediately before the start of the main scanning on the surface of the photoreceptor drum 3, and outputs a BD signal indicating the timing immediately before the start of the main scanning. The timing when the main scanning is started on the photoreceptor drum 3 on which a toner image is to be formed is set according to the BD signal, and writing of the light beam L corresponding to image data is started. Then, a two-dimensional surface (a peripheral surface) of the photoreceptor drum 3 driven by rotation and charged is scanned by the light beam L, and individual electrostatic latent images are formed on the surface of the photoreceptor drum 3.

The housing 201 has a bottom plate 201a of a rectangular shape and four side plates 201b to 201e surrounding the bottom plate 201a. The light beam L that is used for scanning through the deflecting-and-scanning member 223 and that has passed through the fθ lens 231 is emitted to an outside of the housing 201 through an opening 201f formed in the side plate 201e of the housing 201 near of the fθ lens 231 among the side plates 201b to 201e. A second dustproof glass plate 236 (a transparent body) is disposed in the opening 201f. Accordingly, undesired substances, such as dust, are efficiently prevented from entering the housing 201.

### First Embodiment

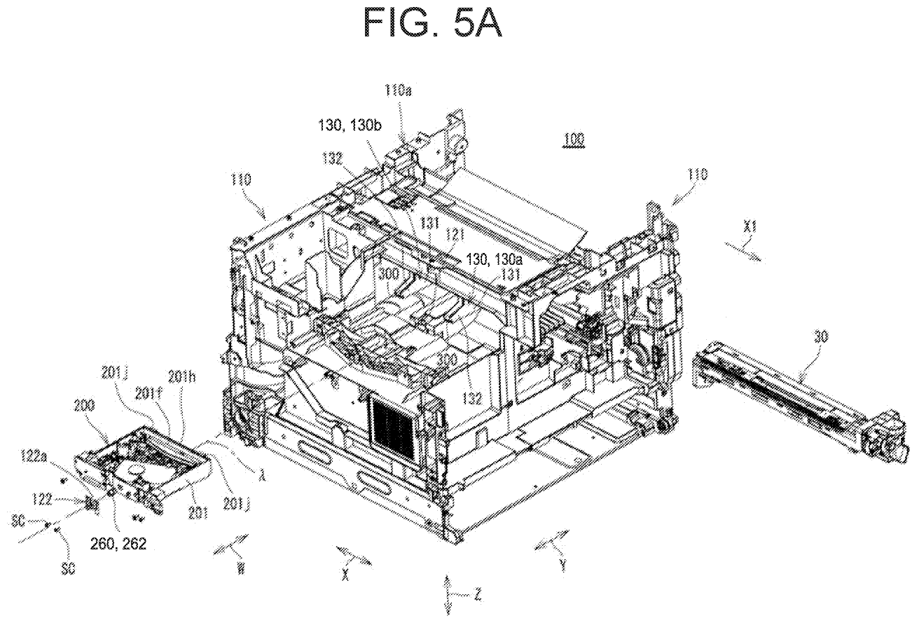

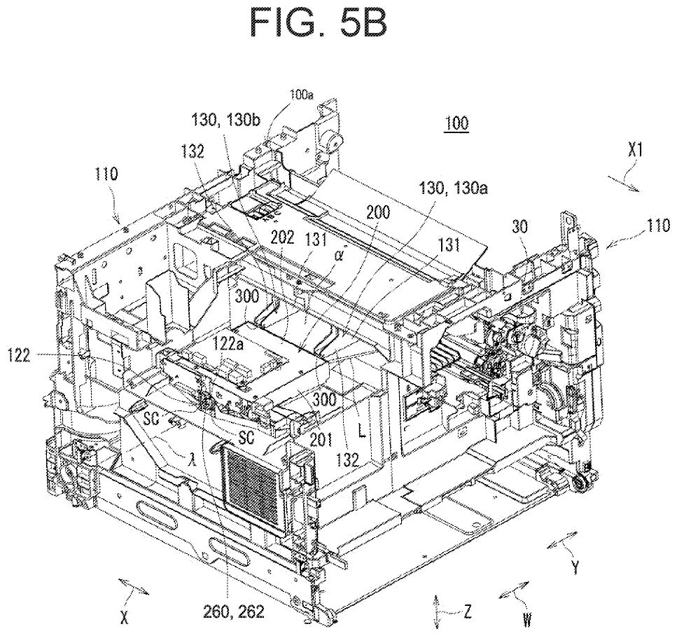

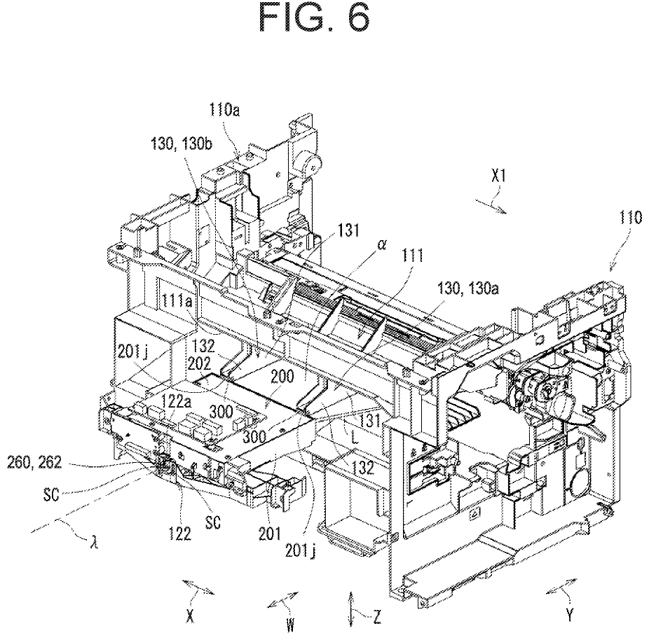

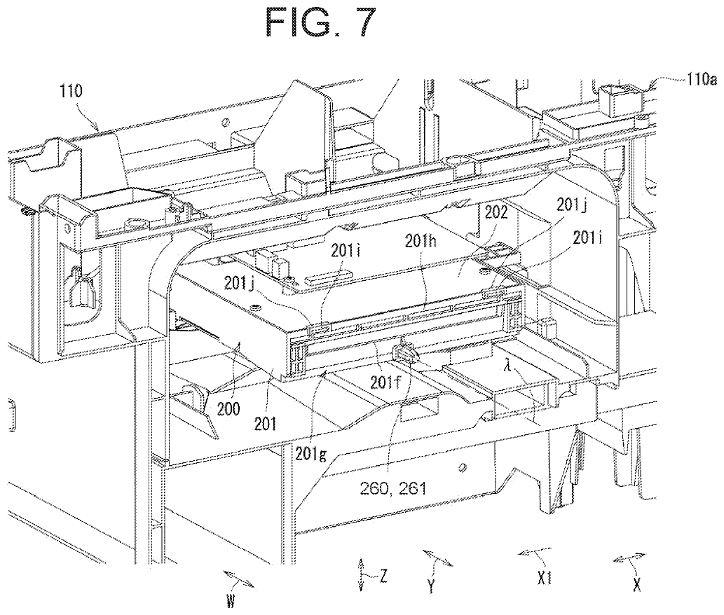

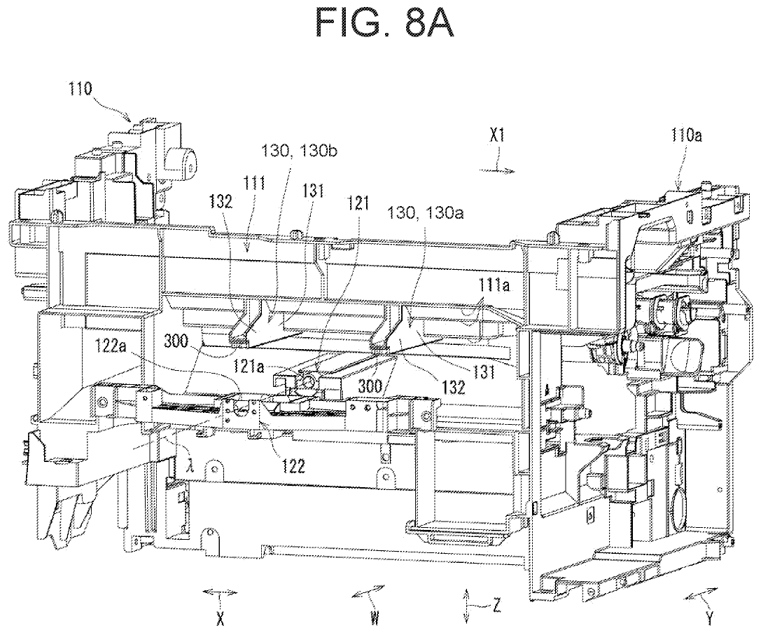

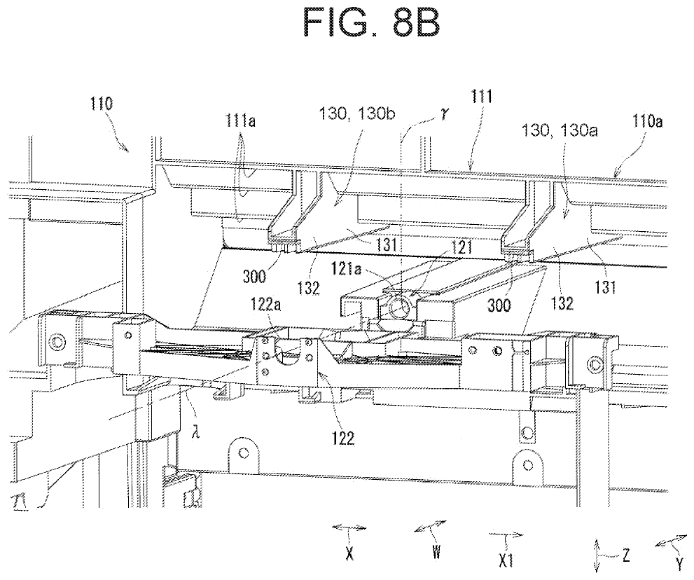

FIGS. 5A and 5B are exploded perspective views of an image-forming apparatus 100 according to a first embodiment in a state before a photoreceptor unit 30 and an optical scanning device 200 are attached to a body frame 110a and a state after the photoreceptor unit 30 and the optical scanning device 200 are attached to the body frame 110a, respectively, as viewed from diagonally above on a front side. Note that the photoreceptor unit 30 includes a photoreceptor drum 3. The optical scanning device 200 illustrated in FIG. 5A has a top cover 202 removed. FIG. 6 is a perspective view of the body frame 110a, viewed from an optical scanning device 200 side, in a state in which a portion of the body frame 110a on the optical scanning device 200 side is removed from the state illustrated in FIG. 5B. FIG. 7 is a perspective view of the opening 201f that emits a light beam L in a state in which a portion of the body frame 110a opposite to the optical scanning device 200 is removed from the state illustrated in FIG. 5B. FIG. 8A is a perspective view of the body frame 110a, viewed from the optical scanning device 200 side, in a state in which the optical scanning device 200 is removed from the state illustrated in FIG. 5B. Furthermore, FIG. 8B is an enlarged perspective view of a holder 130 (130a and 130b) illustrated in FIG. 8A.

As illustrated in FIGS. 5A, 5B, 6, and 7, according to the image-forming apparatus 100 of this embodiment, the optical scanning device 200 is disposed in an image-forming apparatus body 110 such that the optical scanning device 200 is adjustable by turn around a turn axis line a (refer to FIGS. 3A, 3B, 4, 5B, and 6) which is parallel to an axis line which is perpendicular to a main scanning direction X1 of the light beam L on a deflecting-and-scanning surface of the light beam L. A housing 201 of the optical scanning device 200 includes a turn shaft 260 centered on the turn axis line λ. Specifically, in the housing 201 of the optical scanning device 200, a first turn shaft 261 (refer to FIG. 7) is disposed on an emission side of the light beam L of the optical scanning device 200, and a second turn shaft 262 (refer to FIGS. 5A, 5B, and 6) is disposed on an opposite side of the emission side of the optical scanning device 200.

Specifically, the first turn shaft 261 and the second turn shaft 262 have central axis lines on the same axis line and are formed in a cylindrical shape along an orthogonal direction W (a lateral direction Y in this example) that is orthogonal to the main scanning direction X1 of the light beam L on the optical scanning device 200 side.

As illustrated in FIGS. 8A and 8B, in the image-forming apparatus body 110 (the body frame 110a), a shaft support 121 (a cylindrical portion in this example) is disposed on the emission side of the light beam L of the optical scanning device 200. The shaft support 121 has a hole 121a extending in the orthogonal direction W. The first turn shaft 261 is inserted into the hole 121a of the shaft support 121. An inside diameter of the hole 121a is slightly (by a certain amount) larger than an outer diameter of the first turn shaft 261 so that the first turn shaft 261 can turn around the turn axis line λ relative to the hole 121a.

Furthermore, a support member 122 having a U-shaped concave portion 122a is disposed on a portion of the image-forming apparatus body 110 (the body frame 110a) that is opposite to the emission side of the light beam L of the optical scanning device 200. The second turn shaft 262 is supported by the support member 122. A width and an inside diameter of a lower side of the concave portion 122a is slightly (by a certain amount) larger than an outer diameter of the second turn shaft 262 so that the second turn shaft 262 can turn around the turn axis line λ relative to the concave portion 122a. The support member 122 is fixed to a portion of the body frame 110a that is opposite to the emission side of the light beam L by a plurality of fixing members (screws)SC-SC (refer to FIG. 6).

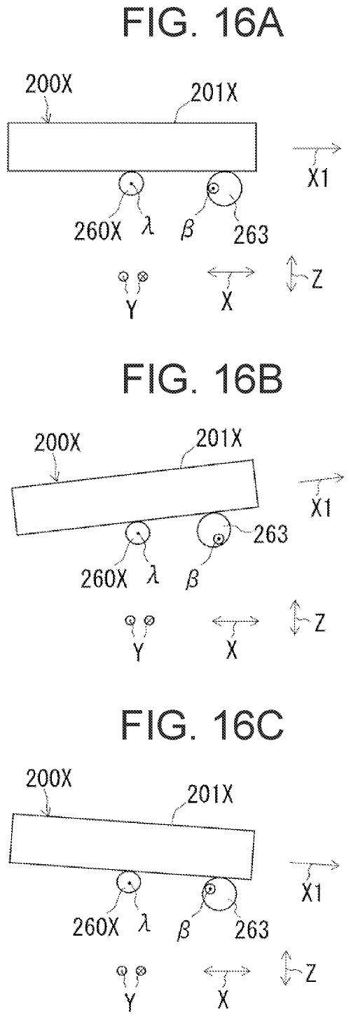

Note that the configuration in which the optical scanning device 200 is adjusted by turn around the turn axis line X is the same as the general configuration described above with reference to FIGS. 16A to 16C, and therefore, a description thereof is omitted.

A certain portion of the housing 201 (for example, a portion of the housing 201 that is opposite to the emission side of the light beam L) is fixed on the image-forming apparatus body 110 by the fixing members SC-SC, such as screws, such that a scanning trajectory a of the light beam L is parallel to a rotation axis line 6 of the photoreceptor drum 3 (refer to FIG. 3A) which acts as an image carrier. Specifically, any portion of the housing 201 (e.g., a portion of the housing 201 on the emission side of the light beam L in this example) is not be fixed to the image-forming apparatus body 110 by the fixing members SC-SC.

Therefore, vibration from the image-forming apparatus body 110, such as vibration caused by drive of the image former 102 or vibration caused by drive of the sheet transport system 103 in the image-forming apparatus body 110, may be transmitted to the optical scanning device 200, and accordingly, an image written on the photoreceptor drum 3 may be disrupted and image defects may occur.

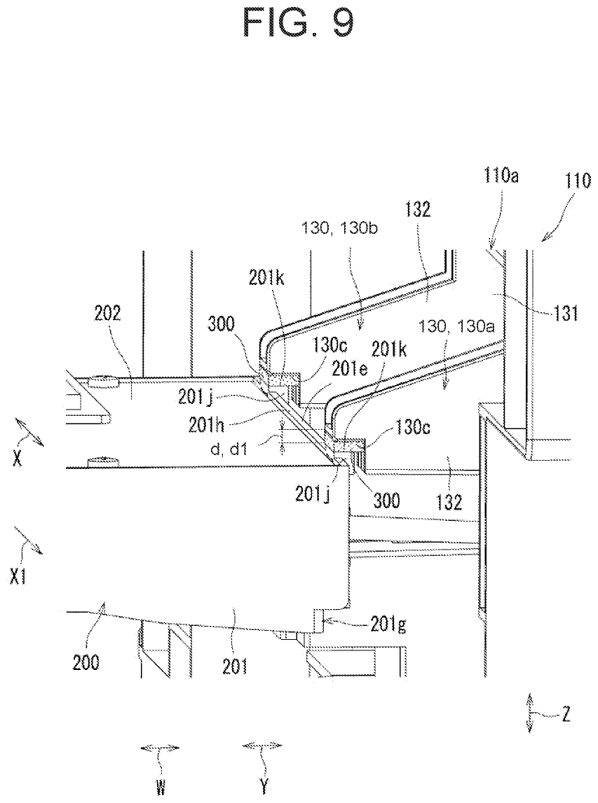

In this regard, the image-forming apparatus 100 according to this embodiment is configured as illustrated in FIG. 9.

FIG. 9 is a perspective view of the holder 130 (130a and 130b) illustrated in FIG. 8A with the optical scanning device 200 held via an example of elastic members 300.

The image-forming apparatus body 110 (the body frame 110a) has the shaft support 121 that supports the optical scanning device 200 such that the optical scanning device 200 can turns around the turn axis line λ and the holder 130 which faces the housing 201 of the optical scanning device 200 at a position different from that of the shaft support 121. The optical scanning device 200 is held by the image-forming apparatus body 110 (the body frame 110a) in a state in which the elastic members 300 (cushioning members) are sandwiched in a pressed manner between the housing 201 (the side plate 201e on the emission side of the light beam L in this embodiment) and the holder 130.

In this way, in the image-forming apparatus 100 of this embodiment, the optical scanning device 200 is held by the image-forming apparatus body 110 in a state in which the elastic members 300 are sandwiched in the pressed manner between the housing 201 and the holder 130, and therefore, vibration from the image-forming apparatus body 110, such as vibration caused by drive of the image former 102 or vibration caused by drive of the sheet transport system 103 in the image-forming apparatus body 110, may be absorbed by the elastic members 300. Therefore, transmission of the vibration from the image-forming apparatus body 110 to the optical scanning device 200 can be suppressed, and accordingly, occurrence of image defects due to disturbances of an image written to the photoreceptor drum 3 can be efficiently suppressed. This is especially effective in a case where any portion of the housing 201 (the portion of the housing 201 on the emission side of the light beam L in this example) is not fixed to the image-forming apparatus body 110 by the fixing members SC-SC, such as screws.

Here, portions of the housing 201 of the optical scanning device 200 that are not fixed to the image-forming apparatus body 110 by the fixing members SC-SC are easily vibrate due to vibration from the image-forming apparatus body 110.

In this regard, in this embodiment, the elastic members 300 are disposed in portions of the housing 201 which are not fixed to the image-forming apparatus body 110 by the fixing members SC-SC.

Accordingly, since the elastic members 300 are disposed in portions that are not fixed by the fixing members SC-SC on the image-forming apparatus body 110 in the housing 201, vibration from the image-forming apparatus body 110 may be absorbed by the elastic members 300 in the portions that are easily vibrated by the vibration from the image-forming apparatus body 110. Therefore, transmission of the vibration from the image-forming apparatus body 110 to the optical scanning device 200 can be further suppressed, and accordingly, occurrence of image defects due to disturbances of an image written to the photoreceptor drum 3 can be further efficiently suppressed.

Although general antivibration members may be used as material of the elastic members 300, the material is not limited to these and a solid rubber material, such as chloroprene rubber or silicone rubber may be used. Although hardness of the elastic members 300 may be approximately 25±5 degrees, for example, the hardness is not limited to this. The hardness of the elastic members 300 may be determined according to JISK 6253.

Although a thickness of the elastic members 300 when the elastic members 300 are not disposed between the housing 201 (in this example, the upper surface 201k of the housing 201) and the holder 130 (in this example, a lower surface 130c of the holder 130) may be a thickness (3 mm in this example) 1.5 times to twice a distance d (d1) (2 mm in this example) between (the upper surface 201k of) the housing 201 and (the lower surface 130c of) the holder 130 (refer to FIG. 9), the thickness is not limited to this.

Here, when the turn shaft 260 centered on the turn axis line λ is disposed in a portion having lower strength in the housing 201, the housing 201 is likely to flex when the optical scanning device 200 is turned around the turn axis line λ, and therefore, an optical member (an fh lens 231, for example) in the housing 201 is distorted and an appropriate image may not be obtained. On the other hand, a bottom 201g (a bottom plate 201a) has the highest strength in strength distribution in the housing 201.

In this regard, in this embodiment, the optical scanning device 200 has the turn shaft 260 which has the turn axis line λ as a center (an axial center) on the bottom 201g of the housing 201 and which is supported by the shaft support 121 in a turn available manner. Specifically, the first turn shaft 261 (refer to FIG. 2A) having the turn axis line λ as its axis center is disposed on the emission side of the light beam L of the bottom 201g in the housing 201, and the second turn shaft 262 (refer to FIG. 2B) having the turn axis line λ as its axis center is disposed on the side opposite to the emission side of the light beam L. Accordingly, the housing 201 does not easily flex when the optical scanning device 200 is turned around the turn axis line λ, and accordingly, distortion of the optical member in the housing 201 may be efficiently suppressed, and as a result, a good image may be obtained.

Furthermore, in this embodiment, the one or more holders 130 (130a and 130b) (one, in this example) is disposed on the image-forming apparatus body 110 (the body frame 110a) such that the holders 130 (130a and 130b) are positioned opposite sides in the main scanning direction X1 with the turn axis line λ sandwiched therebetween in a plan view, on a side opposite to the bottom 201g of the housing 201. In this way, the optical scanning device 200 may be held at three portions, that is, the turn shaft 260 disposed on the bottom 201g of the housing 201 and both the holders 130 (130a and 130b) disposed in both sides in the main scanning direction X1 with the turn axis line λ interposed therebetween relative to the turn shaft 260, and accordingly, the housing 201 of the optical scanning device 200 may be stably held and optical characteristics of the optical member in the housing 201 may be maintained.

Note that, from the viewpoint of suppression of vibration from the image-forming apparatus body 110, the holders 130 are preferably disposed opposite end portions in the main scanning direction X1 of the optical scanning device 200. Vibration from the image-forming apparatus body 110 can be further suppressed by the elastic members 300.

In this embodiment, the holder 130 (130a and 130b) has a base 131 and extended portions 132. The base 131 extends downward from a bottom surface 111a of a ceiling 111 (disposed on the emission side of the light beam L of the optical scanning device 200 in this example) (refer to FIGS. 6, 8A, and 8B) in the image-forming apparatus body 110 (the body frame 110a). The extended portions 132 extend from a lower portion of the base 131 toward the housing 201 of the optical scanning device 200.

In this way, even when holders may not be disposed near the center of the upper surface of the optical scanning device 200, the optical scanning device 200 may be held in the image-forming apparatus body 110 in a state in which the elastic members 300 are sandwiched in a pressed manner between the peripheral portion of the housing 201 of the optical scanning device 200 and the holder 130 in the image-forming apparatus body 110.

In this embodiment, the housing 201 has the opening 201f through which the light beam L passes. Here, a portion of the opening 201f of the housing 201 that is opposite to the bottom 201g of is easily flexed by external forces.

In this regard, according to this embodiment, the holder 130 (130a and 130b) is disposed, in the opening 201f (refer to FIGS. 2A, 3A, and 3B), on the image-forming apparatus body 110 (the body frame 110a) such that the holder 130 (130a and 130b) is located on a side opposite to the bottom 201g of the housing 201.

Since the holder 130 (130a and 130b) is disposed on the opposite side of the bottom 201g of the housing 201 in the opening 201f, vibration from the image-forming apparatus body 110 can be easily absorbed by the elastic members 300 in the vicinity of the opposite sides of the bottom 201g of the opening 201f of the housing 201 that is easily flexed by external force.

In this embodiment, the housing 201 has a beam 201h (refer to FIGS. 2A, 3A, 7, and 9) extending in the main scanning direction X1. Here, the beam 201h extending in the main scanning direction X1 of the housing 201 is easily flexed due to an external force.

In this regard, according to this embodiment, the holder 130 is disposed on the image-forming apparatus body 110 (the body frame 110a) such that the holder 130 (130a and 130b) is disposed, on the beam 201h, on an opposite side of the bottom 201g of the housing 201 in the beam 201h.

Since the holder 130 (130a and 130b) is disposed on the opposite side of the bottom 201g of the housing 201 in the beam 201h, vibration from the image-forming apparatus body 110 can be easily absorbed by the elastic members 300 on the opposite side of the bottom 201g of the beam 201h extending in the main scanning direction X1 of the housing 201.

In this example, the housing 201 has the opening 201f through which the light beam L passes such that the beam 201h extending in the main scanning direction X1 is configured in a portion (an upper portion) opposite to the bottom 201g of the housing 201.

In this embodiment, slits 201i (refer to FIGS. 2A and 7) extending in the main scanning direction X1 are disposed in positions of the beam 201h corresponding to the holder 130 (130a and 130b). In this example, areas around the slits 201i are reinforced with reinforcements 201j (refer to FIGS. 2A, 2B, 7, and 9).

Since the slits 201i extending in the main scanning direction X1 are formed in the positions of the beam 201h corresponding to the holder 130 (130a and 130b), vibration from the image-forming apparatus body 110 is more easily absorbed by the elastic members 300 using the slits 201i that are easily deformed in an elastic manner by external force and that extend in the main scanning direction X1 (although reinforced by the reinforcements 201j in this embodiment).

In this embodiment, the holder 130 (130a and 130b) of the image-forming apparatus body 110 (the body frame 110a) has lower surfaces 130c (refer to FIG. 9) facing upper surfaces 201k (refer to FIG. 9) of the housing 201. The elastic members 300 are disposed between the upper surfaces 201k of the housing 201 of the optical scanning device 200 and the lower surfaces 130c of the holder 130 (130a and 130b) of the image-forming apparatus body 110 (the body frame 110a). In this way, vibration from the image-forming apparatus body 110 in a direction intersecting with the lower surfaces 130c may be easily absorbed by the elastic members 300. Accordingly, transmission of the vibration from the image-forming apparatus body 110 in the direction intersecting with the lower surfaces 130c to the optical scanning device 200 may be suppressed.

### Second Embodiment

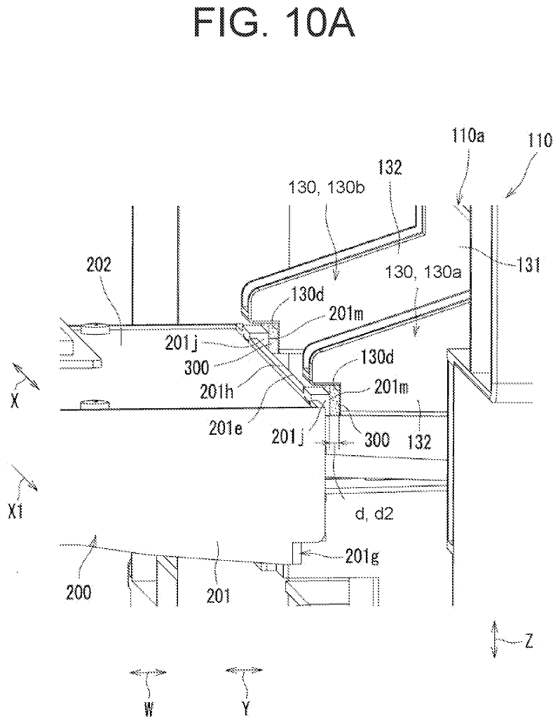

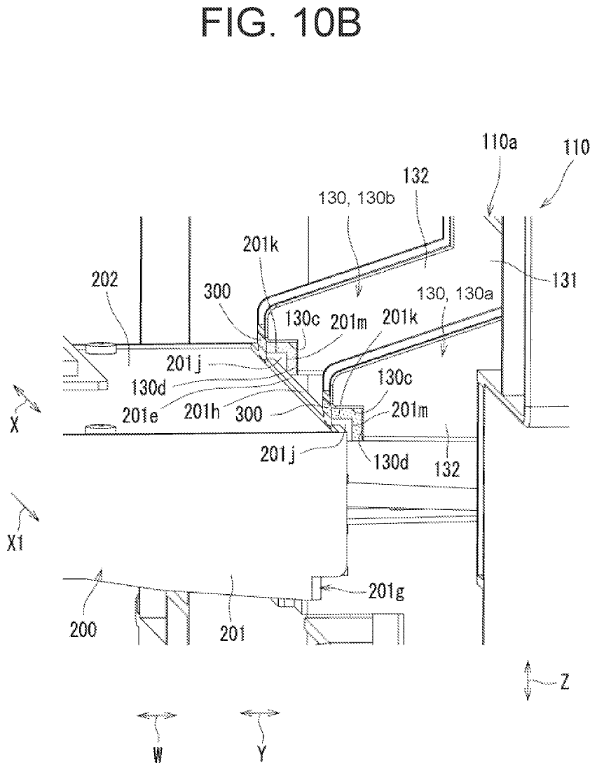

FIGS. 10A and 10B are perspective views of a holder 130 (130a and 130b) illustrated in FIG. 9 with an optical scanning device 200 held via an example and another example of an elastic member 300 in the image-forming apparatus 100 according to a second embodiment. Note that, in FIG. 10B, the example illustrated in FIG. 9 is combined with the example illustrated in FIG. 10A. Here, the elastic member 300 obtained by combining the example illustrated in FIG. 9 and the example illustrated in FIG. 10A is formed as a single unit.

In the second embodiment, components the same as those in the first embodiment are denoted by reference numerals the same as those of the first embodiment, and descriptions thereof are omitted.

In this embodiment, the holder 130 (130a and 130b) of an image-forming apparatus body 110 (a body frame 110a) has a side surface 130d facing a side surface 201m of a housing 201. The elastic member 300 is disposed between side surfaces 201m of the housing 201 of the optical scanning device 200 and the side surfaces 130d of the holders 130 of the image-forming apparatus body 110 (the body frame 110a). In this way, vibration from the image-forming apparatus body 110 in a direction intersecting with the side surfaces 130d may be easily absorbed by the elastic member 300. Accordingly, transmission of vibration from the image-forming apparatus body 110 in the direction intersecting with the side surfaces 130d to the optical scanning device 200 may be suppressed.

Although a thickness of the elastic member 300 when the elastic member 300 is not disposed between the housing 201 (in this example, the side surfaces 201m) and the holder 130 (in this example, the side surfaces 130d) may be a thickness (3 mm in this example) 1.5 times to twice a distance d (d2) (2 mm in this example) between (the side surface 201m of) the housing 201 and (the side surface 130d of) the holder 130 (refer to FIG. 10A), the thickness is not limited to this.

### Third Embodiment

Although the plurality of holders 130 are disposed in the first and second embodiments, a single holder may be disposed.

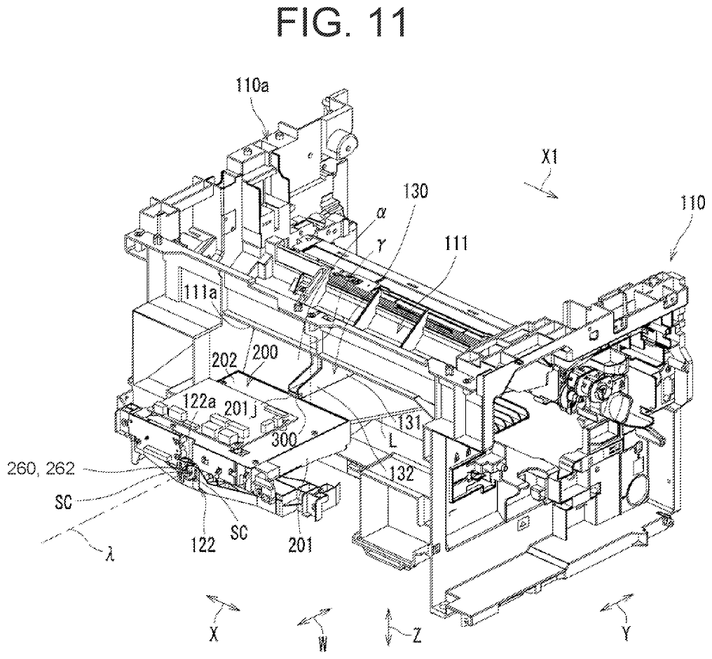

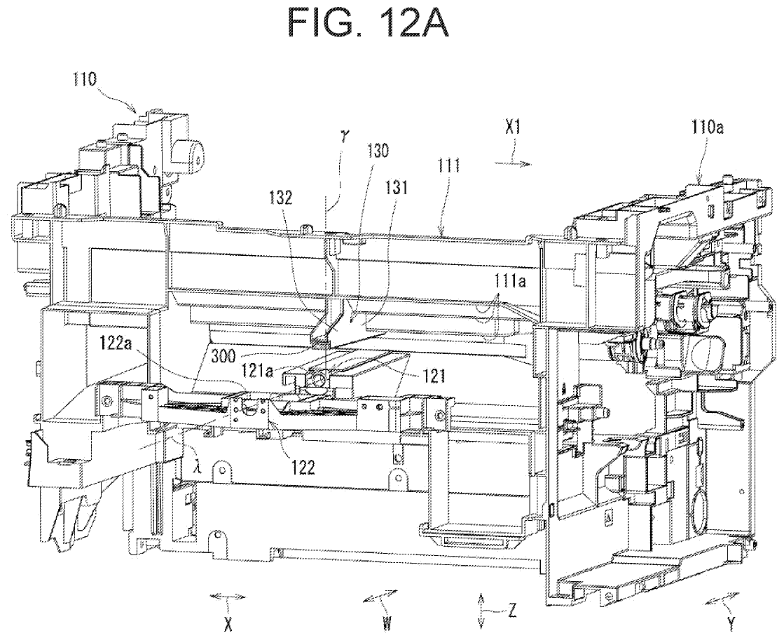

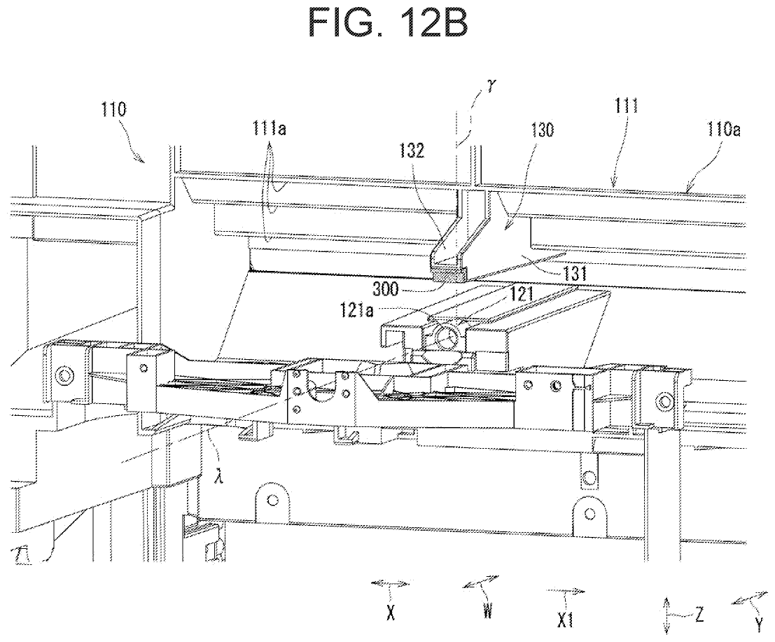

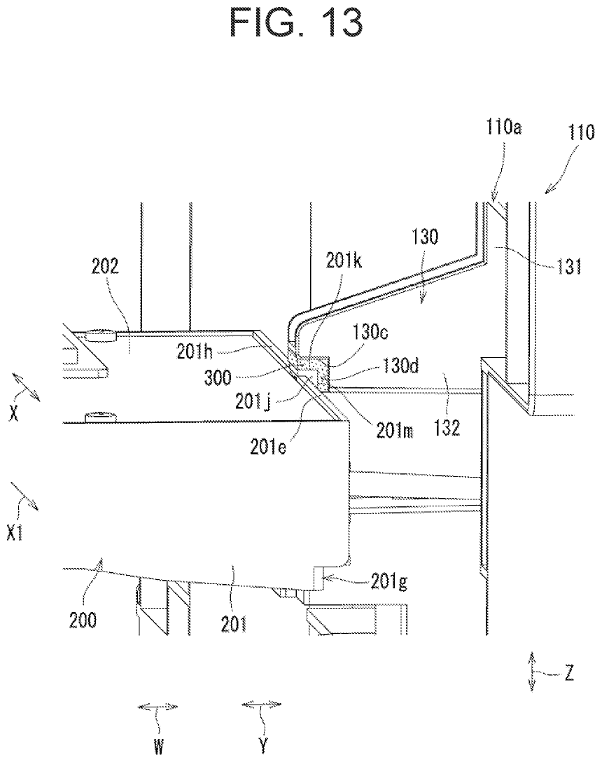

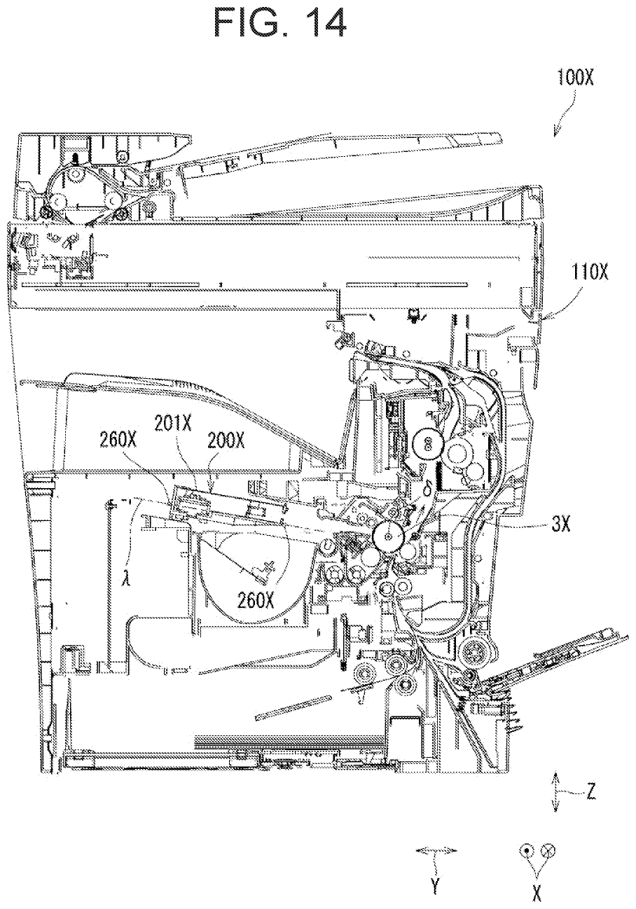

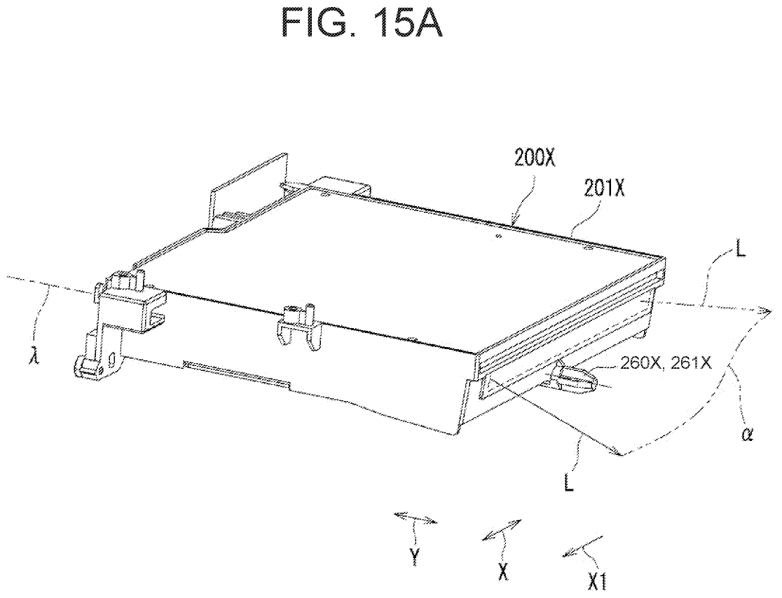

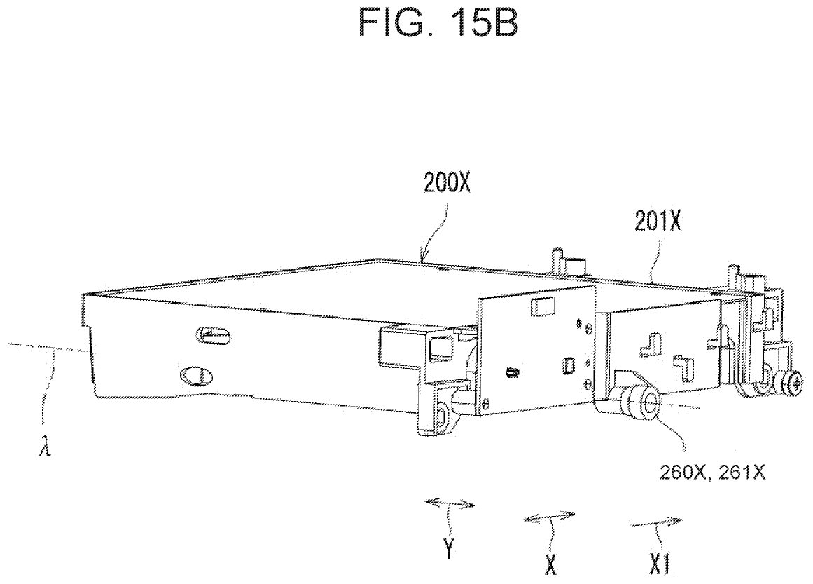

FIG. 11 is a perspective view of a body frame 110a, viewed from an optical scanning device 200 side, in a state in which a portion on the optical scanning device 200 side of the body frame 110a is removed from an image-forming apparatus 100 according to a third embodiment. FIG. 12A is a perspective view of the body frame 110a, viewed from the optical scanning device 200 side, in a state in which the optical scanning device 200 is removed from the image-forming apparatus 100 according to the third embodiment. FIG. 12B is an enlarged perspective view of a holder 130 illustrated in FIG. 12A. FIG. 13 is a perspective view of the holder 130 illustrated in FIGS. 12A and 12B with the optical scanning device 200 held via an example of an elastic member 300 in the image-forming apparatus 100 according to the third embodiment. Note that, in FIG. 13, the example illustrated in FIG. 9 is combined with the example illustrated in FIG. 10A.

According to this embodiment, the holder 130 is disposed on an opposite side of a bottom 201g of a housing 201 and on the image-forming apparatus body 110 (the body frame 110a) such that the holder 130 is located on an imaginary plumb line y that passes a turn axis line λ in a plan view. In this way, the housing 201 is not easily twisted when the optical scanning device 200 is turned around the turn axis line a and fixed to the image-forming apparatus body 110, and accordingly, distortion of an optical member in the housing 201 may be efficiently suppressed, and as a result, a good image may be obtained. In addition, vibration from the image-forming apparatus body 110 can be stably absorbed by the elastic member 300.

### OTHER EMBODIMENTS

In the first and second embodiments, the holders 130 are disposed on the opposite sides in the main scanning direction X1 across the turn axis line λ, and in the third embodiment, the holder 130 is disposed on the imaginary plumb line y passing through the turn axis line λ. However, a configuration obtained by combining these configurations may be employed, that is, a configuration in which holders 130 are disposed on the opposite sides in the main scanning direction X1 across the turn axis line λ and on the imaginary plumb line y passing through the turn axis line λ may be employed.

The present disclosure is not limited to the above-described embodiments but can be implemented in various other forms. Therefore, the embodiments described above are in all respects merely illustrative and should not be interpreted in a limiting manner. The scope of the present disclosure is indicated by the scope of the claims and is not restricted by the text of the specification. Furthermore, all variations and modifications that fall within the equivalent range of the scope of the claims fall within the scope of the present disclosure.

What is claimed is:

1. An image-forming apparatus having an optical scanning device attached to an image-forming apparatus body such that the optical scanning device is adjustable by turn around a turn axis line that is parallel to an axis line orthogonal to a main scanning direction of a light beam on a deflecting-and-scanning surface of the light beam, wherein
the image-forming apparatus body includes a shaft support that supports the optical scanning device in a turn available manner around the turn axis line and a holder that faces a housing of the optical scanning device in a position different from the shaft support, and
the optical scanning device is held by the image-forming apparatus body in a state in which an elastic member is sandwiched between the housing and the holder in a pressed manner.

2. The image-forming apparatus according to claim 1, wherein the optical scanning device includes a turn shaft centered on the turn axis line at a bottom of the housing and is supported by the shaft support in a turn available manner.

3. The image-forming apparatus according to claim 2, wherein the holder is disposed on an opposite side of the bottom of the housing in the image-forming apparatus body such that the holder is positioned opposite sides in the main scanning direction with the turn axis line interposed between the sides in a plan view.

4. The image-forming apparatus according to claim 2, wherein the holder is disposed on an opposite side of the bottom of the housing in the image-forming apparatus body such that the holder is positioned on an imaginary plumb line that passes the turn axis line in a plan view.

5. The image-forming apparatus according to claim 2, wherein
the housing has an opening through which the light beam passes, and
the holder is disposed on the image-forming apparatus body such that the holder is positioned, in the opening, on an opposite side of the bottom of the housing.

6. The image-forming apparatus according to claim 2, wherein
the housing has a beam extending in the main scanning direction, and
the holder is disposed on the image-forming apparatus body such that the holder is positioned, on the beam, on an opposite side of the bottom of the housing.

7. The image-forming apparatus according to claim 6, wherein slits extending in the main scanning direction are disposed in positions corresponding to the holder on the beam.

8. The image-forming apparatus according to claim 1, wherein the elastic member is disposed between an upper surface of the housing of the optical scanning device and a lower surface of the holder of the image-forming apparatus body.

9. The image-forming apparatus according to claim 1, wherein the elastic member is disposed between a side surface of the housing of the optical scanning device and a side surface of the holder of the image-forming apparatus body.

10. The image-forming apparatus according to claim 1, wherein the holder has a base extending downward from a bottom surface of a ceiling plate in the image-forming apparatus body and an extended section extending from a lower portion of the base to the housing of the optical scanning device.

11. The image-forming apparatus according to claim 1, wherein the elastic member is disposed in a position, in the housing, that is not fixed by a fixing member on the image-forming apparatus body.
